(19) United States
(12) Patent Application Publication
(10) Pub. No.: US 2004/0157562 A1
(43) Pub. Date: Aug. 12, 2004

(54) Requests in a communication system

(76) Inventors: Mika Ovaskainen, Helsinki (FI); Anto Mattila, Lempaala (FI); Frank Zillikens, Essen (DE)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/478,864

(22) PCT Filed: May 24, 2002
(86) PCT No.: PCT/IB02/02863

(30) Foreign Application Priority Data
May 25, 2001 (GB) 0112780.2

(51) Int. Cl. H04L 29/06

(52) U.S. Cl. 455/67.11

(57) ABSTRACT

A method for provision of service in a communication system and a communication system is disclosed. When a request for a service is received it is verified if additional information needs to be attached to the request. The verification is based on information stored in the storage means. If it is detected that a service provider requires additional information in association with a request for a service, information associated with said detected requirement is stored in storage means to update said storage means.

### FIELD OF THE INVENTION

The present invention relates to communication between a client and a service provider entity, and in particular, but not exclusively, to a system wherein a request by the client may need to be supported by additional data.

### BACKGROUND OF THE INVENTION

In a communication system a service provider entity may provide a client with various services. For example, a client such as a user terminal may be provided upon request with information associated with a specific subject or with other data. The other data can be, without limiting to these, video or other image data, voice data, an executable program or means required for executing a program and so on. In this specification all data provided by the service provider entity to clients will be referred to by the term “content”. The client may be any entity that may make use of the content or other services provided by the service provider entity.

A client may request for a service from a service provider entity such as from an application server. A request by the client may be first routed to an intermediate server entity. The intermediate server entity in located on the message path between the client entity and the application server. The intermediate server entity can be seen as acting as a client to the application server entity. The original client in turn is the client for the intermediate server entity.

The service application entity may be identified by the means of a uniform resource locator (URL) or similar address indicator. The intermediate server entity receives the request and forwards the request to the service application entity.

The service application entity may need additional data associated with the client in order to be able to provide the requested content. However, the service application entity may notice after reception of the request that the request does not contain all data that is required for provisioning of the requested content. The service application entity may thus need to request more information from the intermediate server entity. In the prior art this is accomplished by means of a message that indicates that additional data is needed. Said message may also contain information what kind of additional data the service application entity needs.

The intermediate server entity receives the message and in response thereto collects the requested additional data and sends either the additional data or a new request incorporating the requested additional data. The new request may be a repeat of the original request such that it includes also said additional data.

The service application entity may thus need to receive the new request before being capable of generating and returning any content in response to the request. The additional signalling between the service application provisioning entity and the intermediate node consumes communication resources. This kind of operation is also time consuming. The queries also cause additional workload for the service provider entity. This may reduce the number of request that can be served in a given time, e.g. per second.

### SUMMARY OF THE INVENTION

Embodiments of the present invention aim to address one or several of the above problems.

According to one aspect of the present invention, there is provided a method in a communication system, the method comprising: detecting that a service provider requires additional information in association with a request; storing in storage means information associated with said detected requirement; receiving a request; and verifying if additional information needs to be attached to the request based on information stored in the storage means.

According to another aspect of the present invention there is provided a communication system comprising a service provider adapted for provision of content in response to a request for a service and storage means for storing information associated with the service provider, said storage means being adapted to be updated to contain information associated with a requirement of additional information to be attached to said request in response to an event indicative of such requirement.

According to another aspect of the present invention there is provided a server of a communication system, comprising: means for determining if additional information in association with requests for services is required by service providers; storage means for storing information associated with said requirements; means for processing requests for services; and means for verifying if additional information needs to be attached to the requests for services based on information stored in the storage means.

In a form of the invention said storing of information is triggered by a request by the service provider for additional information. The service provider may send said request for additional information in response to receiving a request for service that is insufficient from the information content thereof. A failed request may also trigger said step for storing information. An operator may also trigger said step for storing information.

The received request may originate from a client. The request from the client may be received at an intermediate node comprising said storage means. Said intermediate node may be adapted to accomplish said verification and subsequent thereto to transfers the request with or without the additional information to the service provider. Said verification may also be accomplished by client.

Said additional information may be collected based on information stored in the storage means.

Said request may include address information associated with the service provider. Said address information may comprise a universal resource locator (ULR) of the service provider.

The step of storing information associated with said detected requirement may comprise storing information about the address of the service provider. The step of verifying may comprise checking if information associated with the address of the service provider can be found from the storage means.

Information associated with detected requirements may be stored adaptively in the storage means during the operation of the communication system.

The embodiments of the invention may provide advantage in that there is no longer a need for an additional message transfer between a server entity and a service application entity. The service provisioning may be made quicker than before. A service provider may be provided with improved possibilities to handle more request in a given time.

### BRIEF DESCRIPTION OF DRAWINGS

For better understanding of the present invention, reference will now be made by way of example to the accompanying drawings in which;

FIG. 1 shows one embodiment of the present invention; and

FIG. 2 is a flowchart illustrating the operation of an embodiment of the present invention.

### DESCRIPTION OF PREFERRED EMBODIMENTS OF THE Invention

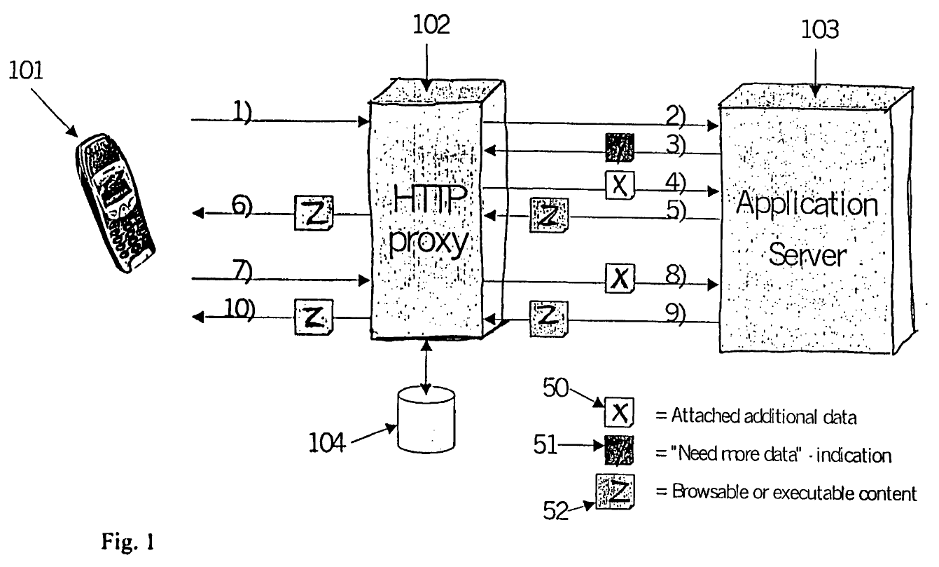

Reference is first made to FIG. 1 which shows a system comprising a client entity 101, an intermediate node 102, and a service application server entity 103. It shall be appreciated that a typical communication network comprises a number of entities such as various stations, routers, switches, controllers, registers and so on. However, these known entities are not an essential part of the present invention and are thus not shown or described herein.

The client entity 101 may be any entity that is adapted to request for a service from the service application server entity 103 and to make use of content provided by the service application entity 103 in response to said request. The content may be used, for example, for execution of a program employed in provision of a service requested by the client entity 101.

In FIG. 1 the client entity 101 is shown to comprise a mobile station (MS). The mobile station may comprise a mobile telephone or other portable device that may be used for voice and/or data communication by the user thereof. The mobile station 101 may communicate via a wireless interface with a transceiver entity of a cellular communication network in a manner known by the skilled person.

In a more specific embodiment the client entity comprises e.g. a browser function of the mobile station or a computer. The client may also be a program that makes use of content provided by the service application entity 103. The intermediate node 102 is located on the message path between the client 101 and the service application server entity 103. The intermediate node 102 is adapted to act as a client to the service provider entity 103. The mobile station 101, in turn, is the client for the intermediate node 102.

The intermediate node 102 ray, for example, comprise a proxy server. The intermediate proxy server may be arranged to operate in accordance with an appropriate transfer protocol such as the hypertext transfer protocol (HTTP) or similar. The intermediate node may also comprise a wireless application protocol (WAP) gateway. Any other entity providing the appropriate gateway function between the client entity 101 and the service provider entity 103 may also be used.

The service application server 103 may be adapted run on a HTTP server or similar. The service application entity 103 may also be provided by means of a dedicated program. The service application entity 103 may need additional data associated with the client in order to response a service request with appropriate content.

However, as discussed above the initial service request generated by the client may not include all required data. Such additional data may comprise information regarding the location of the client entity, authorisation procedures (e.g. passwords, identity codes and so on), subscriber data or any other data that the service provisioning entity 103 may require for service provisioning.

To address the provisioning of the additional data a persistent storage means 104 is provided in association with the intermediate node 102. The storage means is adapted to store indications of services that require additional data to be associated with a service request. The storage means 104 may, for example, store the addresses of such service providers that require the additional information. The address information may comprise any address information such as universal resource locators (URL).

The persistent storage means 104 may be e.g. used to hold a list or similar record e.g. of those universal resource locators requiring additional data and also the additional data that is required. If a URL associated with a request can be found from the list this means that the service pointed by that URL needs additional data to be attached to the request.

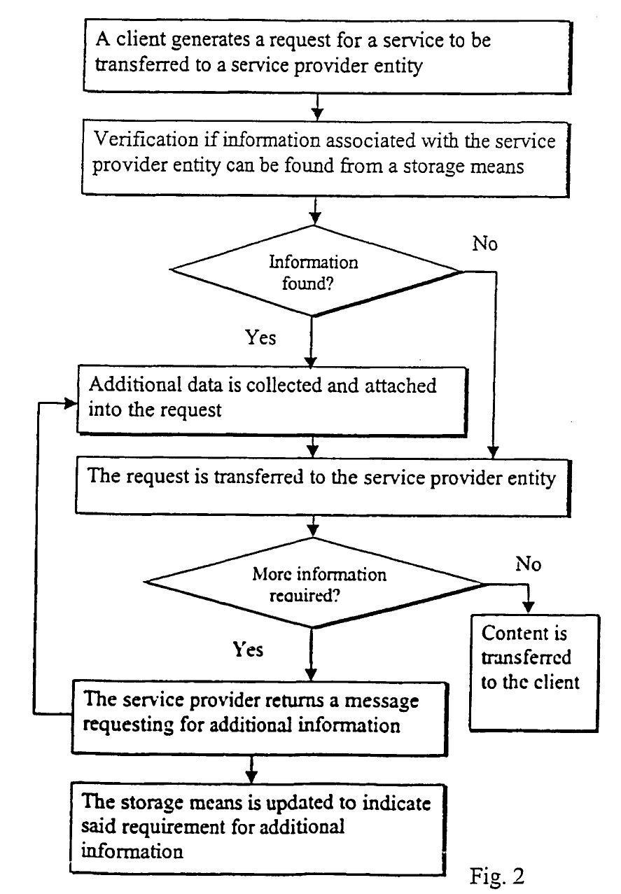

The following will describe a possible operation with reference also to the flowchart of FIG. 2.

The client entity 101 may initiate service provisioning by sending a request 1) for content to the service provisioning server 103. The source of the service is indicated by the means of a uniform resource locator (URL) of the service provisioning server 103.

The intermediate server 102 receives the request 1). The intermediate server 102 then verifies if the URL can be found from the persistent storage means 104. If the URL is found then the intermediate server 102 fetches and/or generates the additional data that the service application 103 needs.

A description of the additional data may also be stored in the storage means 104. The intermediate node then collects the data from appropriate sources and attaches the data in the request. For example, if the additional data comprises location information the intermediate node may request location information e.g. from a location service node, from the mobile station client itself and so on.

After having attached all required data to the request the intermediate server 102 sends the request to the service application 103 with the additional data.

If the intermediate server 102 does not find the URL from the list in the persistent storage means 104, the request car be transported to the application service 103 without attaching any additional data thereto.

In FIG. 1 the URL of the request 1) was not found to be included the list in the storage means 104. Therefore the intermediate server entity 102 did not attach any additional data to the request 2) that was forwarded from the intermediate server 102 to the service application entity 103.

When the service application entity 103 receives the request 2) it, however, notices that the request does not contain all data that is required. The service application 103 may thus respond to the intermediate server 102 with a message 3) that indicates that additional data is needed, as indicated by box 51). The message may contain information regarding the additional data that is needed by the service application entity 103.

The intermediate server 102 receives the response and notices that additional data is needed by the service application 103. The intermediate server 102 saves the URL of said request to the persistent storage means 104. The intermediate server also collects the requested additional data and sends request 4) incorporating the requested additional data 50). The message 4) may be a repeat of the request 1) together with said additional data.

When the service application entity 103 receives the new request 4) it can generate content based on the additional data. The service application 103 then responds with the content 5). The intermediate server 102 receives the Content and delivers it further to the client entity 101 by a message 6) as a response to the original request 1) by the client entity 101.

When the client entity 101 sends a new request 7) associated with the same URL again the intermediate server 102 can now find said URL from the persistent storage means 104 because the ULR was stored in response to the step 3) above. Based on this the intermediate server 102 knows that this URL needs additional data to be attached to the request.

Step 3) also provided the intermediate node with description of the data that needs to be provided for the service provision entity 103. The intermediate node 102 may thus then collect and/or generate the additional data 50) and attach the additional data to the request 8) to be sent to the service application 103.

The service application entity 103 then generates the content based on the additional data and returns the content in a response 9). The intermediate node 102 then delivers the response 10) to the client 101.

To summarise the learning procedure, a service application entity may require additional information from an intermediate node to be attached to a request for a service. Upon realising this, the intermediate node may store the URL or other identity information that associated with the service application entity in a storage means. During further interactions with clients, the intermediate node may then immediately check from the storage means whether the request needs to be augmented with additional information prior to its transmission to the service application entity.

In addition to operations cycles as described with reference to message 2) to 5) of FIG. 1, the intermediate node may be adapted to learn from instances wherein additional information is required in response to other events. For example, a failed service request may be used to indicate that additional data is required. The operator may also teach the intermediate node to recognise such request that require additional information.

The additional information can thus be attached without a need for a roundtrip between the intermediate node and the service application. This eliminates the additional transfer needed between intermediate and service application.

According to a further embodiment the client entity 101 is provided with appropriate storage and verification functions. That is, the client entity 101 may be adapted to store information regarding the requirements of various service providers. Before sending a request for a service the client entity may check if any additional requirements are known to it. If so, the client entity 101 itself may arrange the provision of the additional data to the service provisioning entity.

The client entity may, for example, gather the required information by itself or ask another node, such as the intermediate node, to collect and attach the required information to the request.

According to an embodiment a default set of attributes or similar additional information parameters is stored in the database 104. As a default, these attributes are then sent together with service requests to all URLs. However, if a URL associated with a request is found from the database, this indicates that the request is an the exceptions to the default rule.

It is also possible to store information associated with groups of service providers so that a service provider of the group will be provided or alternatively will not be provided with the additional information.

It should be appreciated that whilst embodiments of the present invention have been described in relation to mobile stations, embodiments of the present invention are applicable to any other suitable type of user equipment.

It is also noted herein that while the above describes exemplifying embodiments of the invention, there are several variations and modifications which may be made to the disclosed solution without departing from the scope of the present invention as defined in the appended claims.

1. A method in a communication system, the method comprising:
detecting that a service provider requires additional information in association with a request;
storing in storage means information associated with said detected requirement;
receiving a request; and
verifying if additional information needs to be attached to the request based on information stored in the storage means.

2. A method as claimed in claim 1, wherein a request by the service provider for additional information triggers said step for storing information.

3. A method as claimed in claim 2, wherein the service provider sends said request for additional information in response to receiving a request that is insufficient from the information content thereof.

4. A method as claimed in any preceding claim wherein a failed request triggers said step for storing information.

5. A method as claimed in any preceding claim, wherein an operator triggers said step for storing information.

6. A method as claimed in any preceding claim wherein the received request originates from a client.

7. A method as claimed in claim 6, wherein the request from the client is received at an intermediate node comprising said storage means, said intermediate node accomplishes said verification, and subsequent to the verification transfers the request with or without the additional information to the service provider.

8. A method as claimed in claim 6, wherein the client accomplishes said verification prior transmission of the request.

9. A method as claimed in any preceding claim, wherein said additional information is collected based on information stored in the storage means.

10. A method as claimed in claims 8 and 9, wherein the client collects said additional data.

11. A method as claimed in claims 7 and 9, wherein the intermediate node collects said additional data.

12. A method as claimed in any preceding claim, wherein said request includes address information associated with the service provider.

13. A method as claimed in claim 12, wherein said address information comprises a universal resource locator (ULR) of the service provider.

14. A method as claimed in any preceding claim, wherein the step of storing information associated with said detected requirement comprises storing information about the address of the service provider.

15. A method as claimed in any of claims 12 to 14, wherein the step of verifying comprising checking if information associated with the address of the service provider can be found from the storage means.

16. A method as claimed in claim 6 or any claim when appended to claim 6, wherein the client entity comprises a mobile station.

17. A method as claimed in any preceding claim, said additional information being selected from the following list: location data; authorisation data; subscriber data.

18. A method as claimed in any preceding claim, wherein information associated with detected requirements is stored adaptively in the storage means during the operation of the communication system.

19. A communication system comprising a service provider adapted for provision of content in response to a request for a service and storage means for storing information associated with the service provider, said storage means being adapted to be updated to contain information associated with a requirement of additional information to be attached to said request in response to an event indicative of such requirement.

20. A communication system as claimed in claim 19, wherein the event comprises at least one of: a request by the service provider for additional information; a failed request for service; instructions by the operator of the communication system.

21. A communication system as claimed in claim 19 or 20, comprising a client generating the request for the service.

22. A communication system as claimed in claim 21, wherein the request from the client is received by an intermediate node comprising said storage means, said intermediate node being arranged to update the storage means and to attach the additional information to request send to the service provider.

23. A communication system as claimed in claim 22, wherein the intermediate node is adapted to collect said additional information based on information stored in the storage means.

24. A communication system as claimed in claim 22 or 23, wherein the intermediate node comprises a proxy server.

25. A communication system as claimed in any of claims 22 to 24, wherein intermediate node is adapted to operate in accordance with the hypertext transfer protocol (http).

26. A communication system as claimed in claim 22 or 23, wherein the intermediate node comprises a gateway.

27. A comrunication system as claimed in claim 26, wherein the gateway is adapted to operate in accordance with the wireless application protocol (WAP).

28. A server of a communication system, comprising:
means for determining if additional information in association with requests for services is required by service providers;
storage means for storing information associated with said requirements;
means for processing requests for services; and
means for verifying if additional information needs to be attached to the requests for services based on information stored in the storage means.
